(19) United States
(12) Patent Application Publication
(10) Pub. No.: US 2025/0219670 A1
(43) Pub. Date: Jul. 3, 2025

(54) Smart Bracelet Device

(71) Applicant: Richard DiPasquale, Folly Beach, SC (US)

(72) Inventor: Richard DiPasquale, Folly Beach, SC (US)

(21) Appl. No.: 18/985,133

(22) Filed: Dec. 18, 2024

Related U.S. Application Data
(60) Provisional application No. 63/616,922, filed on Jan. 2, 2024.

(51) Int. Cl. H04B 1/3827; A44C 5/00; G06F 1/16; H04L 67/306; H04W 4/80

(52) U.S. Cl. CPC H04B 1/385; A44C 5/0015; G06F 1/163; H04L 67/306; H04W 4/80

(57) ABSTRACT

A smart bracelet device is disclosed, which is a modified bracelet that will both align and connect with other bracelets to send messages without discussing uncomfortable subjects and opinions or will connect a person with another that can help them with their situation. The smart bracelet device comprises a base component that is an annulus configured to be secured around a user's wrist during use. The base component comprises Bluetooth technology, a processor, a memory, and other components and circuitry to communicate with other people wearing the smart bracelet device. Further, the base component utilizes an internal algorithm to identify people who have shared interests or if a person is available to help them. Further, the smart bracelet device can be individually programmed or pre-programmed via a USB connection to a PC/MAC for programming and charging.

### CROSS-REFERENCE TO RELATED APPLICATION

The present application claims priority to, and the benefit of, U.S. Provisional Application No. 63/616,922, which was filed on Jan. 2, 2024, and is incorporated herein by reference in its entirety.

### FIELD OF THE INVENTION

The present invention relates generally to the field of smart bracelet devices. More specifically, the present invention relates to a smart bracelet designed to connect to other people wearing the bracelet and identify conversation partners or someone that can help them with their particular issue. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in smart bracelet devices. Generally, people may enjoy conversing with others about their hobbies and interests, especially interests like sports and politics. However, meeting strangers may leave people feeling uneasy if they cannot identify a shared interest. Further, divulging opinions and interests in conversations and social media can lead to conflict with others that people want to avoid.

In other situations, a person may need to connect or make immediate contact with someone in a public place or event that they are present at. This may be necessary for a multitude of reasons (i.e., medical, language, etc.). In these situations, they are unable to make contact or communicate what they need verbally or on their devices and require another a means of communication.

Accordingly, there is a demand for an improved smart bracelet device that features a color-coded system to alert other people wearing the bracelet of shared interests or if they are available to help. More particularly, there is a demand for a smart bracelet device that utilizes an internal algorithm to identify people of shared interest.

Therefore, there exists a long felt need in the art for a smart bracelet device that provides users with a smart bracelet designed to connect to other people wearing the bracelet and identify conversation partners or someone that can help them with their particular issue. There is also a long felt need in the art for a smart bracelet device that features a color-coded system that darkens in color if two people agree on a subject or if someone can help them with a particular issue. Further, there is a long felt need in the art for a smart bracelet device that lightens in color if a person disagrees with another or if there is no one available to help them. Moreover, there is a long felt need in the art for a device that utilizes an internal algorithm to identify people who have shared interests or if a person is available to help them with their particular issue. Further, there is a long felt need in the art for a smart bracelet device that prevents people from committing social faux pas due to uncomfortable conversations and subjects. Finally, there is a long felt need in the art for a smart bracelet device that gives immediate feedback to someone in need who is also wearing the bracelet device.

The subject matter disclosed and claimed herein, in one embodiment thereof, comprises a smart bracelet device. The device is a modified bracelet that will both align and connect with other bracelets to send messages without discussing uncomfortable subjects and opinions or will connect a person with another that can help them with their situation. The smart bracelet device comprises a base component that is an annulus configured to be secured around a user's wrist during use. The base component comprises Bluetooth technology, a processor, a memory, and other components and circuitry to communicate with other people wearing the smart bracelet device. Further, the base component utilizes an internal algorithm to identify people who have shared interests or if a person is available to help them. The device uses a color system to let others know of their shared or differing opinions and displays a color on the base component's exterior. For example, a green color signifies complete agreement, a red color signifies complete disagreement, a yellow color can be used for mixed opinions, etc. Further, the smart bracelet device can be individually programmed or pre-programmed via a USB connection to a PC/MAC for programming and charging.

In this manner, the smart bracelet device of the present invention accomplishes all of the forgoing objectives and provides users with a device that connects to other people wearing the device. The device is a bracelet that is secured around a user's wrist. The device can connect with others wearing the smart bracelet device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart bracelet device. The device is a modified bracelet that will both align and connect with other bracelets to send messages without discussing uncomfortable subjects and opinions or will connect a person with another that can help them with their situation. The smart bracelet device comprises a base component that is secured around a user's wrist during use. The base component communicates with other people wearing the smart bracelet device. Further, the base component utilizes an internal algorithm to identify people who have shared interests or if a person is available to help them. The device uses a color system to let others know of their shared or differing opinions and displays a color on the base component's exterior surface.

In one embodiment, the smart bracelet device allows users to connect to other people wearing the smart bracelet devices. The device identifies conversation partners or signals individuals who can offer help, as needed. The smart bracelet device allows other users of the devices to become aware of shared interests and opinions, preventing uncomfortable conversations and subjects.

In one embodiment, the smart bracelet device comprises a base component that is configured in a circular ring or doughnut-shaped configuration that allows the base component to be secured around a user's wrist during use. The base component can also be an annular body with rounded, curved sides and a hollow interior.

In one embodiment, the base component is available in different sizes and shapes depending on the size of a user's wrist. In one embodiment, the base component can be slipped over a user's hand and retained around a user's wrist for use. In another embodiment, the base component comprises a clasp that can be opened and closed, as needed. The clasp allows a user to open the ring-shaped base component, then secure the clasp with the base component around a user's wrist for use.

In one embodiment, the hollow interior of the base component comprises a Bluetooth wireless communication module, a processor, a memory, a rechargeable battery, and other components and circuitry to communicate with other people wearing a smart bracelet device. The processor and memory are for receiving and storing information that is gathered or created by an internal algorithm. The Bluetooth wireless communication module allows the smart bracelet devices to interact with other smart bracelet devices based on information created by the internal algorithm. Once the smart bracelet device interacts with other smart bracelet devices, the memory acts to remember the interactions and saves the data to be communicated with the processor for future use and interactions.

In one embodiment, the base component utilizes an internal algorithm to identify people who have shared interests or if a person is available to help them. The internal algorithm is in communication with the processor and memory to activate the color system, as needed. The color system is activated when a user's smart bracelet device communicates with other smart bracelet devices within range via the Bluetooth wireless communication module of the base component. The internal algorithm is proprietary to the device.

In one embodiment, the smart bracelet device can be individually programmed via the processor or pre-programmed via a USB port which establishes a connection to a PC/MAC for programming and charging, as needed. This programming allows a user to program inputs for the internal algorithm, making the internal algorithm aware of a user's likes/dislikes, interests, opinions, etc. The programming can also allow for input, as to what languages a user speaks or other specific skills, such that the internal algorithm can alert other smart bracelet users who may require a translator or someone of other specific skills.

In one embodiment, the smart bracelet device is in communication with a smart device via a mobile application or website through the Bluetooth wireless communication module. The mobile application or website allows a user to wirelessly program inputs for the internal algorithm, making the internal algorithm aware of a user's likes/dislikes, interests, opinions, etc. The mobile application or website can also allow for input, as to what languages a user speaks or other specific skills, such that the internal algorithm can alert other smart bracelet users who may require a translator or someone of other specific skills.

In one embodiment, the base component comprises a plurality of LEDs for illumination of the exterior surface of the base component. The plurality of LEDs allow the exterior to be lighted with a variety of colors, such as red, green, blue, yellow, etc. The device uses a color system to let others know of their shared or differing opinions and displays a color on the base component's exterior surface. For example, a green color signifies complete agreement, a red color signifies complete disagreement, a yellow color can be used for mixed opinions, etc. The plurality of LEDs are in communication with the processor, such that the processor dictates which colors to display. Typically, the LEDs are powered by a rechargeable battery for use.

In one embodiment, the rechargeable battery powers the smart bracelet device and provides the power supply for the components and circuitry to communicate. In one embodiment, the battery is a rechargeable lithium battery. The base component also comprises a USB port for charging the rechargeable battery, as needed.

In one embodiment, the base component comprises a display screen. The display screen is electrically connected with the processor and memory and displays information, such as the time, power low indicators, power on/off indicators, etc. Typically, the display screen is preferably a curved surface component that is an electronic liquid crystal screen embedded within the exterior surface of the base component.

In one embodiment, the base component comprises a power button for powering on and off the device. Further, in one embodiment, the length of the time of pressing the button changes the content the display screen shows.

In one embodiment, the base component is manufactured of a silicone or rubber material or any suitable, soft flexible material that would be comfortably worn by a user or combination of such materials.

In yet another embodiment, the smart bracelet device comprises a plurality of indicia.

In yet another embodiment, a method of connecting with others to identify conversation partners is disclosed. The method includes the steps of providing a smart bracelet device comprising a base component with a processor and memory. The method also comprises securing the base component around a user's wrist and turning it on. Further, the method comprises programming the base component with a user's preferences, opinions, and topics. The method also comprises communicating with a second smart bracelet device worn by another person. The method comprises turning the base component colors depending on the other person's opinions, preferences, and topics, etc. Finally, the method comprises detecting that someone in the vicinity needs help to communicate.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the smart bracelet device of the present invention in accordance with the disclosed architecture;

FIG. 2 illustrates a perspective view of one embodiment of the smart bracelet device of the present invention showing the smart bracelets communicating with other smart bracelets in accordance with the disclosed architecture;

FIG. 3 illustrates a perspective view of one embodiment of the smart bracelet device of the present invention showing the device in use on a user's wrist in accordance with the disclosed architecture; and

FIG. 4 illustrates a flowchart showing the method of connecting with others to identify conversation partners in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a smart bracelet device that provides users with a smart bracelet designed to connect to other people wearing the bracelet and identify conversation partners or someone that can help them with their particular issue. There is also a long felt need in the art for a smart bracelet device that features a color-coded system that darkens in color if two people agree on a subject or if someone can help them with a particular issue. Further, there is a long felt need in the art for a smart bracelet device that lightens in color if a person disagrees with another or if there is no one available to help them. Moreover, there is a long felt need in the art for a device that utilizes an internal algorithm to identify people who have shared interests or if a person is available to help them with their particular issue. Further, there is a long felt need in the art for a smart bracelet device that prevents people from committing social faux pas due to uncomfortable conversations and subjects. Finally, there is a long felt need in the art for a smart bracelet device that gives immediate feedback to someone in need who is also wearing the bracelet device.

The present invention, in one exemplary embodiment, is a novel smart bracelet device. The device is a modified bracelet that will both align and connect with other bracelets to send messages without discussing uncomfortable subjects and opinions or will connect a person with another that can help them with their situation. The smart bracelet device comprises a base component that is an annulus configured to be secured around a user's wrist during use. The base component comprises Bluetooth technology, a processor, a memory, and other components and circuitry to communicate with other people wearing the smart bracelet device. Further, the base component utilizes an internal algorithm to identify people who have shared interests or if a person is available to help them. The device uses a color system to let others know of their shared or differing opinions and displays a color on the base component's exterior. For example, a green color signifies complete agreement, a red color signifies complete disagreement, a yellow color can be used for mixed opinions, etc. Further, the smart bracelet device can be individually programmed or pre-programmed via a USB connection to a PC/MAC for programming and charging. The present invention also includes a novel method of connecting with others to identify conversation partners. The method includes the steps of providing a smart bracelet device comprising a base component with a processor and memory. The method also comprises securing the base component around a user's wrist and turning it on. Further, the method comprises programming the base component with a user's preferences, opinions, and topics. The method also comprises communicating with a second smart bracelet device worn by another person. The method comprises turning the base component colors depending on the other person's opinions, preferences, and topics, etc. Finally, the method comprises detecting that someone in the vicinity needs help to communicate.

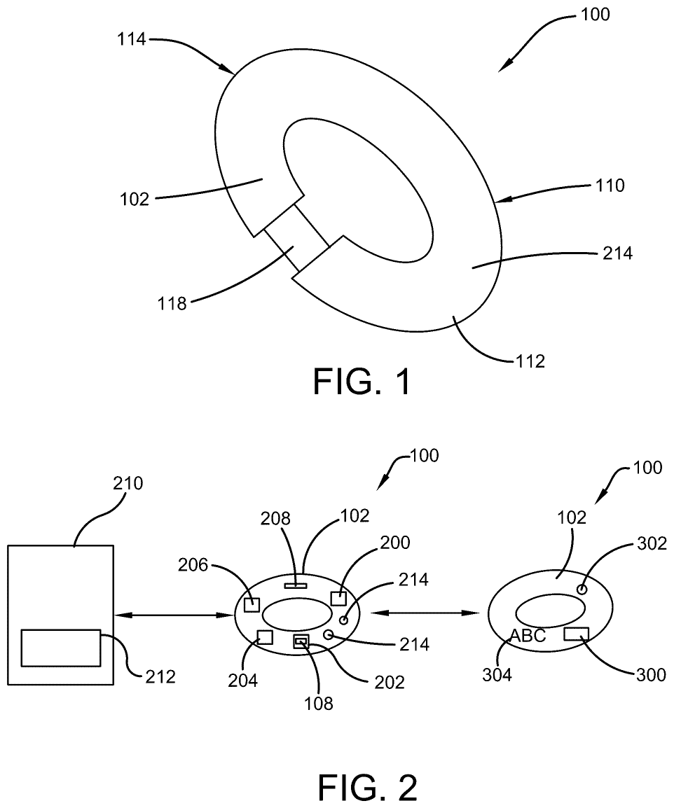

Referring initially to the drawings, FIG. 1 illustrates a perspective view of one embodiment of the smart bracelet device 100 of the present invention. In the present embodiment, the smart bracelet device 100 is an improved smart bracelet device 100 that provides a user 106 with a bracelet that connects with other bracelets to send messages. Specifically, the smart bracelet device 100 comprises a base component 102 configured to be secured around a user's wrist 104 during use. The base component 102 communicates with other people wearing the smart bracelet device 100. Further, the base component 102 utilizes an internal algorithm 108 to identify people who have shared interests or if a person is available to help them. The device 100 uses a color system to let others know of their shared or differing opinions and displays a color on the base component's exterior surface 110.

Generally, the smart bracelet device 100 allows users 106 to connect to other people wearing the smart bracelet devices 100. The device 100 identifies conversation partners or signals individuals who can offer help, as needed. For example, if someone needed a translator, the device 100 could alert a user 106 of others who could offer such translation services. The smart bracelet device 100 allows other users 106 of the devices 100 to become aware of shared interests and opinions, preventing uncomfortable conversations and subjects.

Further, the smart bracelet device 100 comprises a base component 102 that is configured in a circular ring or doughnut-shaped configuration that allows the base component 102 to be secured around a user's wrist 104 during use. The base component 102 can also be an annular body with rounded, curved sides 112 and a hollow interior 114.

Typically, the base component 102 is available in different sizes and shapes depending on the size of a user's wrist 104. In one embodiment, the base component 102 can be slipped over a user's hand 116 and retained around a user's wrist 104 for use. In another embodiment, the base component 102 comprises a clasp 118 that can be opened and closed, as needed. The clasp 118 allows a user 106 to open the ring-shaped base component 102, then secure the clasp 118 with the base component 102 around a user's wrist 104 for use.

As shown in FIG. 2, the hollow interior 114 of the base component 102 comprises a Bluetooth wireless communication module 200, a processor 202, a memory 204, a rechargeable battery 206, and other components and circuitry to communicate with other people wearing a smart bracelet device 100. The processor 202 and memory 204 are for receiving and storing information that is gathered or created by an internal algorithm 108. The Bluetooth wireless communication module 200 allows the smart bracelet devices 100 to interact with other smart bracelet devices 100 based on information created by the internal algorithm 108. Once the smart bracelet device 100 interacts with other smart bracelet devices 100, the memory 204 acts to remember the interactions and saves the data to be communicated with the processor 202 for future use and interactions. In one embodiment, the user can wait to activate the bracelet device 100 until another bracelet device 100 is nearby due to ambient conditions, (i.e., other Bluetooth signals in the area).

Further, the base component 102 utilizes an internal algorithm 108 to identify people who have shared interests or if a person is available to help them. The internal algorithm 108 is in communication with the processor 202 and memory 204 to activate the color system, as needed. The color system is activated when a user's smart bracelet device 100 communicates with other smart bracelet devices 100 within range via the Bluetooth wireless communication module 200 of the base component 102. The internal algorithm 108 is proprietary to the device 100.

Additionally, the smart bracelet device 100 can be individually programmed via the processor 202 or pre-programmed via a USB port 208 which establishes a connection to a PC/MAC (not shown) for programming and charging, as needed. This programming allows a user 106 to program inputs for the internal algorithm 108, making the internal algorithm 108 aware of a user's likes/dislikes, interests, opinions, etc. The programming can also allow for input, as to what languages a user speaks or other specific skills, such that the internal algorithm 108 can alert other smart bracelet users 106 who may require a translator or someone of other specific skills.

Furthermore, the smart bracelet device 100 is in communication with a smart device 210 via a mobile application 212 or website through the Bluetooth wireless communication module 200. The mobile application 212 or website allows a user 106 to wirelessly program inputs for the internal algorithm 108, making the internal algorithm 108 aware of a user's likes/dislikes, interests, opinions, etc. The mobile application 212 or website can also allow for input, as to what languages a user speaks or other specific skills, such that the internal algorithm 108 can alert other smart bracelet users 106 who may require a translator or someone of other specific skills.

Typically, the smart device 210 may be a cellular telephone, a tablet, a computer, a remote control, or any other device that may have wireless communication capabilities and may be connected to the internet. The smart device 210 may perform any type of wireless communication, including, but not limited to, WIFI, BLUETOOTH, RFID, NFC, etc. The device 100 further includes a Bluetooth wireless communication module 200 and additional sensors which would allow the device 100 to pair with a mobile application 212 on a smart device 210. Once paired, a user 106 could program the smart bracelet device 100 via the mobile application 212 with their interests, opinions, and likes/dislikes.

Further, the base component 102 comprises a plurality of LEDs 214 for illumination of the exterior surface 110 of the base component 102. The plurality of LEDs 214 allow the exterior to be lighted with a variety of colors, such as red, green, blue, yellow, etc. The device 100 uses a color system to let others know of their shared or differing opinions and displays a color on the base component's exterior surface 110. For example, a green color signifies complete agreement, a red color signifies complete disagreement, a yellow color can be used for mixed opinions, etc. Further, the plurality of LEDs 214 can display a different set of display colors, such as (HOT) red transitioning (COOL) to white to (COLD) blue. The plurality of LEDs 214 are in communication with the processor 202, such that the processor 202 dictates which colors to display. Typically, the LEDs 214 are powered by a rechargeable battery 206 for use.

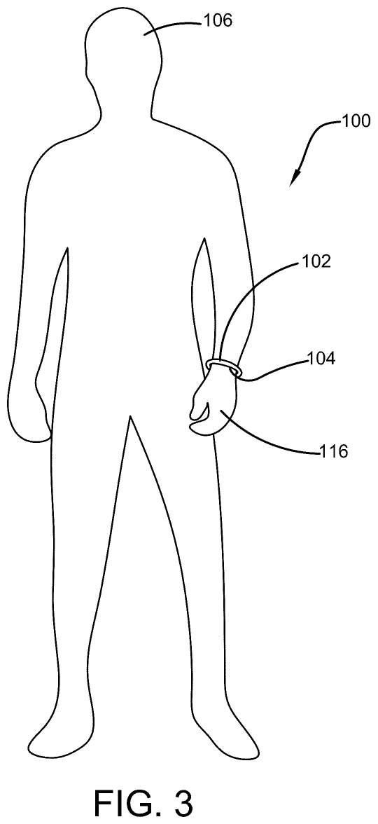

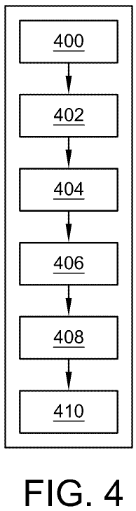

As shown in FIG. 3, the rechargeable battery 206 powers the smart bracelet device 100 and provides the power supply for the components and circuitry to communicate. In one embodiment, the battery 206 is a rechargeable lithium battery. The base component 102 also comprises a USB port 208 for charging the rechargeable battery 206, as needed.

The battery 206 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the smart bracelet device 100. Throughout this specification, the term “battery” may be used interchangeably to refer to one or more wet or dry cells or batteries of cells in which chemical energy is converted into electricity and used as a source of DC power. References to recharging or replacing the battery 206 may refer to recharging or replacing individual cells, individual batteries of cells, or a package of multiple battery cells as is appropriate for any given battery technology that may be used. In addition, a rechargeable embodiment of the battery 206 may be recharged using a USB port 208, wherein the USB port 208 is a USB-A, USB-B, Micro-B, Micro-USB, Mini-USB, or USB-C port, etc.

In one embodiment, the base component 102 comprises a display screen 300. The display screen 300 is electrically connected with the processor 202 and memory 204 and displays information, such as the time, power low indicators, power on/off indicators, etc. Typically, the display screen 300 is preferably a curved surface component that is an electronic liquid crystal screen embedded within the exterior surface 110 of the base component 102.

Further, in one embodiment, the base component 102 comprises a power button 302 for powering on and off the device 100. Further, in one embodiment, the length of the time of pressing the button 302 changes the content the display screen 300 shows.

Additionally, the base component 102 is manufactured of a silicone or rubber material or any suitable, soft flexible material that would be comfortably worn by a user 106 or combination of such materials.

In one embodiment, the smart bracelet device 100 comprises speakers and sensors (not shown) and any other circuitry needed to emit an audio signal when required or the device 100 includes a medical option to automatically send a signal when it detects the absence of a user's heartbeat.

In yet another embodiment, the smart bracelet device 100 comprises a plurality of indicia 304. The base component 102 of the device 100 may include advertising, a trademark, or other letters, designs, or characters, printed, painted, stamped, or integrated into the base component 102, or any other indicia 304 as is known in the art. Specifically, any suitable indicia 304 as is known in the art can be included, such as but not limited to, patterns, logos, emblems, images, symbols, designs, letters, words, characters, animals, advertisements, brands, etc., that may or may not be bracelet, communication, or brand related.

FIG. 4 illustrates a flowchart of the method of connecting with others to identify conversation partners. The method includes the steps of at 400, providing a smart bracelet device comprising a base component with a processor and memory. The method also comprises at 402, securing the base component around a user's wrist and turning it on. Further, the method comprises at 404, programming the base component with a user's preferences, opinions, and topics. The method also comprises at 406, communicating with a second smart bracelet device worn by another person. The method comprises at 408, turning the base component colors depending on the other person's opinions, preferences, and topics, etc. Finally, the method comprises at 410, detecting that someone in the vicinity needs help to communicate.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “smart bracelet device”, “bracelet device”, “smart device”, and “device” are interchangeable and refer to the smart bracelet device 100 of the present invention.

Notwithstanding the forgoing, the smart bracelet device 100 of the present invention can be of any suitable size and configuration as is known in the art without affecting the overall concept of the invention, provided that it accomplishes the above stated objectives. One of ordinary skill in the art will appreciate that the smart bracelet device 100 as shown in FIGS. 1-4 is for illustrative purposes only, and that many other sizes and shapes of the smart bracelet device 100 are well within the scope of the present disclosure. Although the dimensions of the smart bracelet device 100 are important design parameters for user convenience, the smart bracelet device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart bracelet device that provides a user with a bracelet that connects with other bracelets based on interests and opinions, the smart bracelet device comprising:
a base component;
a Bluetooth wireless communication module;
a processor; and
an internal algorithm;
wherein the base component is configured to be secured around a user's wrist during use;
wherein the internal algorithm is used to identify other people wearing a smart bracelet device who have shared interests or opinions;
wherein the Bluetooth wireless communication module allows people wearing the smart bracelet device to interact; and
further wherein the base component displays a color based on the shared interests or opinions.

2. The smart bracelet device of claim 1, wherein the base component is configured in a circular ring or doughnut-shaped configuration with rounded, curved sides and a hollow interior.

3. The smart bracelet device of claim 2, wherein the base component is available in different sizes and shapes depending on a size of a user's wrist.

4. The smart bracelet device of claim 3, wherein the base component is sized to be slipped over a user's hand and retained around a user's wrist for use.

5. The smart bracelet device of claim 3, wherein the base component comprises a clasp that can be opened and closed to secure the base component around a user's wrist for use.

6. The smart bracelet device of claim 3, wherein the hollow interior of the base component comprises the Bluetooth wireless communication module, the processor, and a memory.

7. The smart bracelet device of claim 6, wherein the processor and the memory are for receiving and storing information that is gathered or created by the internal algorithm.

8. The smart bracelet device of claim 7, wherein once the smart bracelet device interacts with other smart bracelet devices, the memory acts to remember interactions and saves data to be communicated with the processor for future use and interactions.

9. The smart bracelet device of claim 8, wherein the internal algorithm is in communication with the processor and the memory to activate the display of color on the base component.

10. The smart bracelet device of claim 9, wherein the display of color is activated when a user's smart bracelet device communicates with other smart bracelet devices within range via the Bluetooth wireless communication module of the base component.

11. The smart bracelet device of claim 10, wherein the smart bracelet device can be individually programmed with a user's interests and opinions via the processor or pre-programmed via a USB port which establishes a connection to a PC/MAC.

12. The smart bracelet device of claim 11, wherein the base component comprises a plurality of LEDs for illumination of an exterior surface of the base component.

13. The smart bracelet device of claim 12, wherein the plurality of LEDs allow the exterior surface to be lighted with a variety of colors, such as red, green, blue, or yellow.

14. The smart bracelet device of claim 13, wherein a rechargeable battery powers the smart bracelet device.

15. A smart bracelet device that provides a user with a bracelet that connects with other bracelets based on interests and opinions, the smart bracelet device comprising:
a base component configured in a circular ring or doughnut-shaped configuration with rounded, curved sides and a hollow interior;
a Bluetooth wireless communication module, a processor, an internal algorithm, and a memory positioned within the hollow interior; and
wherein the base component is configured to be secured around a user's wrist during use;
wherein the internal algorithm is used to identify other people wearing a smart bracelet device who have shared interests or opinions;
wherein the processor and the memory are for receiving and storing information that is gathered or created by the internal algorithm;
wherein once the smart bracelet device interacts with other smart bracelet devices, the memory acts to remember interactions and saves data to be communicated with the processor for future use and interactions;
wherein the internal algorithm is in communication with the processor and the memory to activate a display of color on the base component based on shared interests or opinions;
wherein the display of color is activated when a user's smart bracelet device communicates with other smart bracelet devices within range via the Bluetooth wireless communication module of the base component;
wherein the base component comprises a plurality of LEDs for illumination of an exterior surface of the base component; and
further wherein the smart bracelet device displays a green color to signify complete agreement, a red color to signify complete disagreement, and a yellow color for mixed opinions of others wearing smart bracelet devices.

16. The smart bracelet device of claim 15, wherein the base component comprises a display screen for displaying information, such as time, power low indicators, and power on/off indicators.

17. The smart bracelet device of claim 15, wherein the base component comprises a power button for powering on and off the smart bracelet device.

18. The smart bracelet device of claim 15, wherein the smart bracelet device is in communication with a smart device via a mobile application or website through the Bluetooth wireless communication module, such that the mobile application or website allows a user to wirelessly program inputs for the internal algorithm, making the internal algorithm aware of a user's likes/dislikes, interests, and opinions.

19. The smart bracelet device of claim 15 further comprising a plurality of indicia.

20. A method of connecting with others to identify conversation partners, the method comprising the following steps:
providing a smart bracelet device comprising a base component with a processor and memory;
securing the base component around a user's wrist and turning it on;
programming the base component with a user's preferences, opinions, and topics;
communicating with a second smart bracelet device worn by another person;
turning the base component colors depending on the other person's opinions, preferences, and topics, etc.; and
detecting that someone in the vicinity needs help to communicate.
